(19) United States
(12) Patent Application Publication
(10) Pub. No.: US 2004/0012728 A1
(43) Pub. Date: Jan. 22, 2004

(54) Revolving mechanism of automobile LCD display

(76) Inventor: Ching-Yuan Lu, Chung Ho City (TW)

Correspondence Address: BIRCH STEWART KOLASCH & BIRCH, PO BOX 747, FALLS CHURCH, VA, 22040-0747, US

(21) Appl. No.: 10/195,407

(22) Filed: Jul. 16, 2002

(51) Int. Cl. G02F 1/1333

(52) U.S. Cl. 349/58

(57) ABSTRACT

A revolving mechanism of an automobile LCD display includes a fixing frame on the inner top of an automobile and a LCD display on the bottom of the fixing frame, the fixing frame further consists of a fixing board with a revolving board beneath; the turning board fastens the LCD display on the bottom to make the LCD display turn horizontally with different viewing angles.

### BACKGROUND OF THE INVENTION

I. Field of the Invention

This invention relates generally to a revolving mechanism of the automobile LCD display and, more specifically, to a revolving mechanism of the automobile LCD display that makes the LCD display beneath the inner top of an automobile turn horizontally for best viewing angle.

II. Description of the Prior Art

Heretofore, it is known that audio and video technologies advance rapidly, automobile owners who enjoy audio and video can install LCD display and DVD or VCD player, passengers can watch programs during riding.

Most of the LCD display (a) are installed on the inner top and connected to a connection board (b), as shown in FIG. 4, a plurality numbers of through hole (b1) are on the connection board (b), a screw (c) passes through the through hole (b1) of the connection board (b) and reaches to top of the automobile (not shown in FIG) to fasten the connection board (b) on inner top of the automobile. The LCD display (a) is hinged on one side of a body (a1) to make the LCD display (a) can be turned downward; the LCD display (a) is turned downward first, have a screw (d) passing through the screw hole (a11) on top of the body (a1) and then fix the screw (d) onto the screw hole (b2) of the connection board (b) to fasten LCD display (a) on the bottom of the connection board (b).

The LCD display (a) is fixed on the bottom of the connection board (b) without turning capability. Therefore, the viewing angle of the LCD display (a) can not be adjusted along with passengers for the best angle, this will degrade the program quality.

### SUMMARY OF THE INVENTION

It is therefore a primary object of the invention to provide a revolving mechanism of the automobile LCD display that makes the LCD display beneath the inner top of an automobile turn horizontally for best viewing angle.

In order to achieve the objective set forth, a revolving mechanism of the automobile LCD display in accordance with the present invention comprises a fixing frame on the inner top of an automobile and a LCD display on the bottom of the fixing frame. The fixing frame further consists of a fixing board with a revolving board beneath; the turning board fastens the LCD display on the bottom to make the LCD display turn horizontally with different viewing angles.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is an explosive view of the present invention;

FIG. 3 is a partial cross-sectional view of the present invention;

FIG. 4 is an explosive view of a prior art.

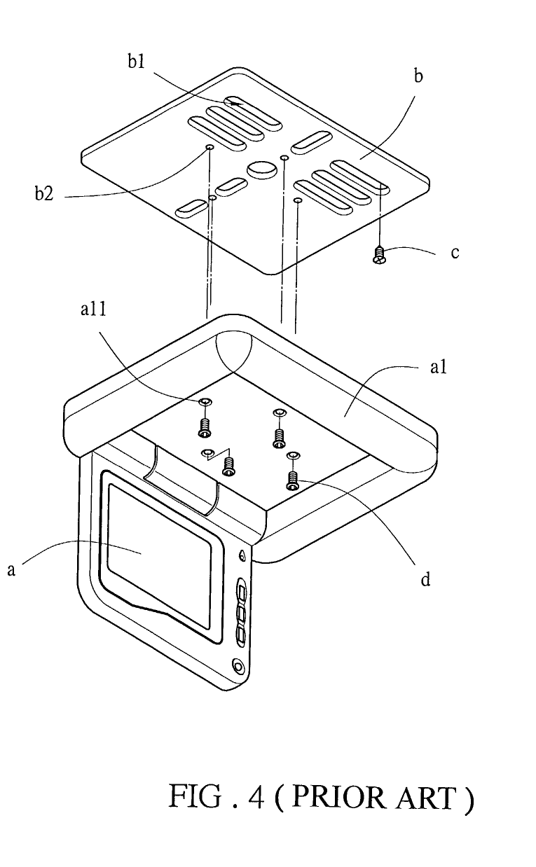

### DESCRIPTION OF THE PREFERRED EMBODIMENT

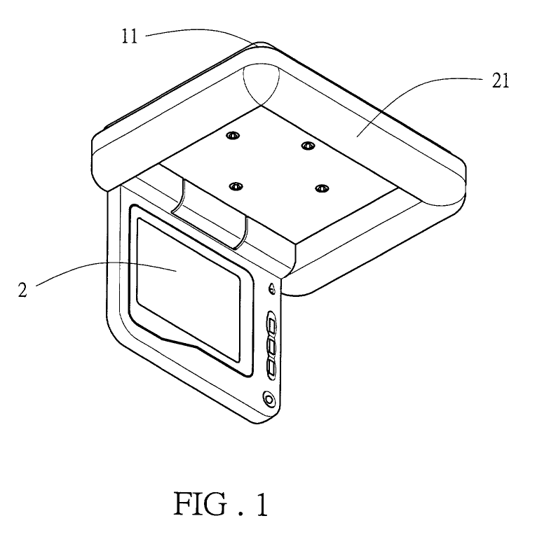

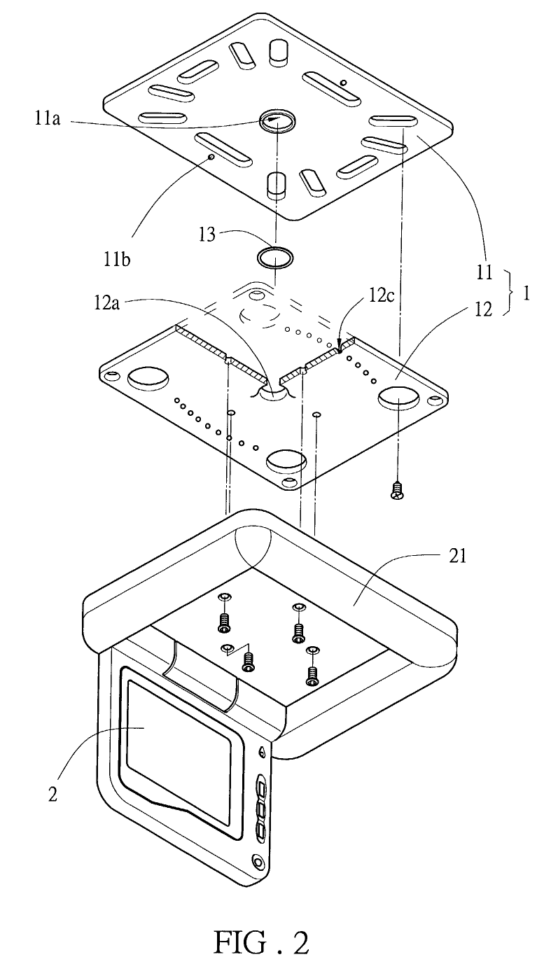

Referring to FIG. 1 and FIG. 2, the present invention is composed of a fixing frame 1 on the inner top of an automobile and a LCD display 2 on the bottom of the fixing frame 1.

The fixing frame 1 further consists of a fixing board 11 with a revolving board 12 beneath; the turning board 12 fastens the LCD display 2 on the bottom to make the LCD display 2 turn horizontally with different viewing angles.

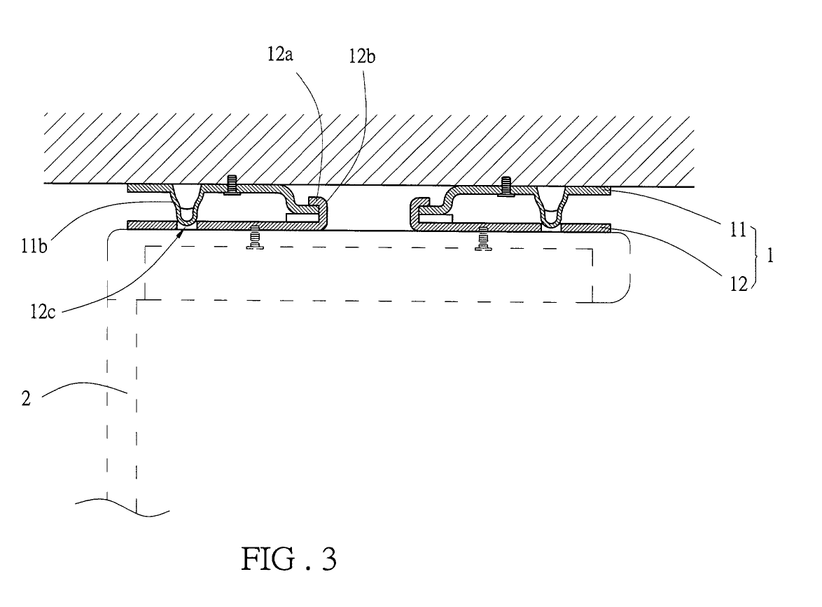

The fixing board 11 has a pivotal hole 11a on center, the revolving board 12 has a hollow pivot 12a accordingly, the hollow pivot 12a is wrapped with a plastic washer 13; the hollow pivot 12a passes through the pivotal hole 11a with the top bent outward and formed a top brim 12b to fasten the revolving board 12 beneath the fixing board 11, as shown in FIG. 3.

At least one positioning protuberant point 11b is beneath the fixing board 11, and a plurality numbers of positioning indented point 12c in curve shape are on the top of the revolving board 12 to adjust the revolving board 12 with proper angle.

Based on structure described above, the LCD display 2 is fixed beneath the revolving board 12 of the fixing frame 1; the LCD display 2 can be adjusted with different angles horizontally as needed. Passengers can turn the LCD display 2 downward and adjust the horizontally for the best viewing angle to make the LCD display 1 face directly for best effect.

A plastic washer 13 is between the fixing board 11 and the revolving board 12; such scheme can make the revolving board 12 turn smoothly.

The positioning protuberant point 11b beneath the fixing board 11 can make the positioning indented point 12c to fix the revolving board 12 in proper location firmly without swinging.

While a preferred embodiment of the invention has been shown and described in detail, it will be readily understood and appreciated that numerous omissions, changes and additions may be made without departing from the spirit and scope of the invention.

What is claimed is:

1. A revolving mechanism of an automobile LCD display comprising:
a fixing frame on the inner top of an automobile with a LCD display on the bottom thereof, said fixing frame further having a fixing board pivoted with a revolving board beneath, said turning board fastens said LCD display on the bottom side thereof to make said LCD display turn horizontally with different angles.

2. The revolving mechanism of an automobile LCD display recited in claim 1, wherein said fixing board having a pivotal hole, said revolving board having a hollow pivot, a plastic washer is mounted on said hollow pivot; said hollow pivot passes through said pivotal hole with the top bent outward and formed a top brim to fasten said revolving board on said fixing board.

3. The revolving mechanism of an automobile LCD display recited in claim 1, wherein at least one positioning protuberant point is beneath said fixing board, a plurality numbers of positioning indented point in curve shape are on the top of said revolving board to adjust said revolving board with proper angle.
